(19) United States
(12) Patent Application Publication
(10) Pub. No.: US 2026/0019497 A1
(43) Pub. Date: Jan. 15, 2026

(54) METHOD AND APPLICATION FOR ESTABLISHING A PHONE CONVERSATION

(71) Applicant: OMER DOTAN, TEL AVIV (IL)

(72) Inventor: OMER DOTAN, TEL AVIV (IL)

(21) Appl. No.: 19/241,407

(22) Filed: Jun. 18, 2025

(30) Foreign Application Priority Data
Jul. 10, 2024 (IL) 314236

(51) Int. Cl. H04M 1/72469; H04W 4/14

(52) U.S. Cl. CPC H04M 1/72469; H04W 4/14

(57) ABSTRACT

An application for establishing a phone conversation, the application including: a menu, for being applicable by a second phone receiving a call from a first phone and prior to establishing the phone conversation, the first menu for communicating a message to the first phone.

### CROSS-REFERENCE TO RELATED APPLICATIONS

This application claims the benefit of priority from Israel 314236 filed Jul. 10, 2024, the disclosure of which is incorporated herein by reference.

### TECHNICAL FIELD

The invention relates to the field of phone calls.

### BACKGROUND

FIG. 1 depicts a prior art application for receiving a phone call.

A driver 22 holding a steering wheel 24, upon receiving an incoming call to phone 50B, an icon 12 is turned on.

The driver may press an icon 16 for receiving the call. However, a passenger 20 might listen to the call, and the call does not know. Thus, the driver may press an icon 14 for rejecting the call.

There is a long felt need to provide a solution to the above-mentioned and other problems of the prior art.

### SUMMARY

An application (10) for establishing a phone conversation (52), the application (10) including:
a menu (28A), for being applicable by a second phone (50B) receiving a call from a first phone (50A) and prior to establishing the phone conversation (52), the first menu (28A) for communicating a first message (30A) to the first phone (50A).

### BRIEF DESCRIPTION OF THE DRAWINGS

Embodiments, features, and aspects of the invention are described herein in conjunction with the following drawings, in which:

FIG. 1 depicts a prior art application for receiving a phone call;

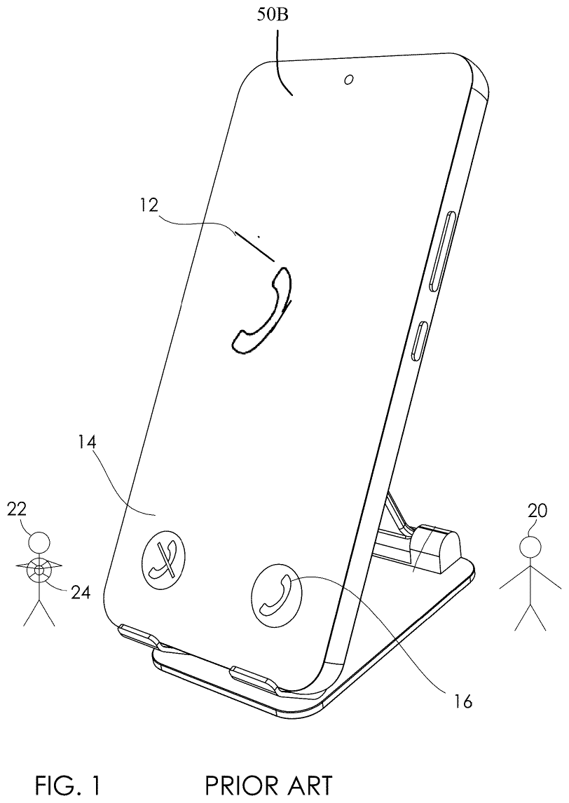

FIG. 2 depicts an application according to one embodiment for receiving a phone call;

FIG. 3 depicts the steps of receiving or rejecting the phone call of FIG. 2; and

FIG. 4 depicts an additional step of receiving or rejecting the phone call of FIG. 3.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

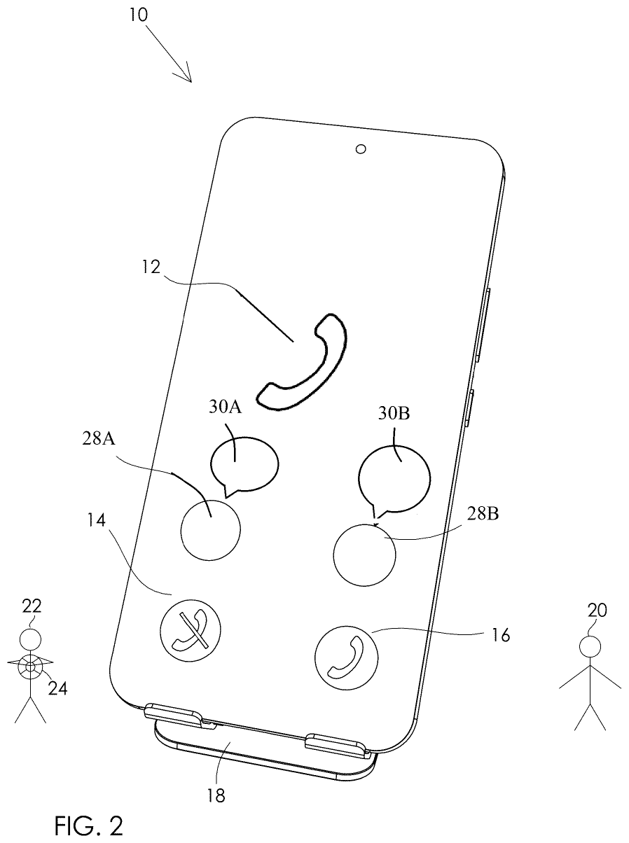

FIG. 2 depicts an application according to one embodiment for receiving a phone call.

The term press an icon and a menu refers as well to a executing a vocal instruction.

Application 10 allows driver 22 receiving the incoming call, to press icon 16 for receiving the call, and to press icon 14 for rejecting the call. Application 10 further includes a third icon, 28A, for allowing driver 22 to send a first pre-prepared voice message 30A, e.g., “I am not alone”; a fourth icon, 28B, for allowing driver 22 to send a second pre-prepared voice message 30B, e.g., “We may speak 3 minutes only”; etc.

According to another embodiment, an artificial intelligence (AI) agent learns the situation and selects, instead of driver 22, between receiving or rejecting the call, or of announcing message 30A of “I am not alone”, or of announcing message 30B of “we may speak 3 minutes only”

Voice message 30A, rather than being pre-prepared, may be real time edited by the AI agent.

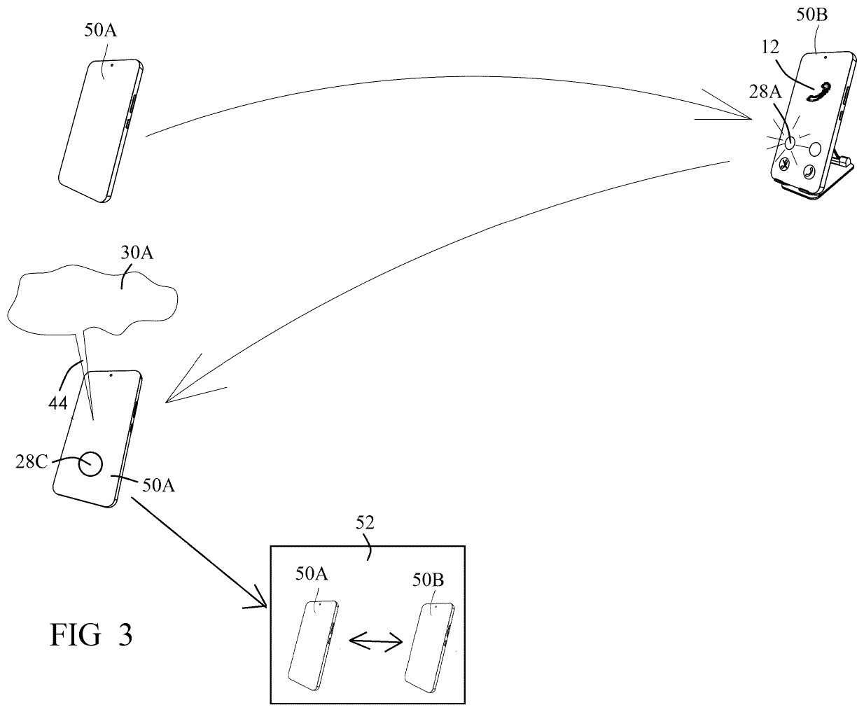

FIG. 3 depicts the steps of receiving or rejecting the phone call of FIG. 2.

At the first step, caller calls by a phone 50A. At the second step, the driver presses icon 28A on phone 50B. At the third step, phone 50B announces (44) pre-prepared message 30A, being in the example “I am not alone”.

According to one embodiment, the user of phone 50A is the dominator, thus may stop the calling by pressing menu 14 or by a vocal instruction; or may then continue the calling for establishing a conversation 52.

According to another additional embodiment, the user of phone 50A must press an icon 28C, for approving the condition, and only then conversation 52 is established.

In case of continuing, driver 22 is calm that the conversation 52 is established only after the user of phone 50B has received message 30A.

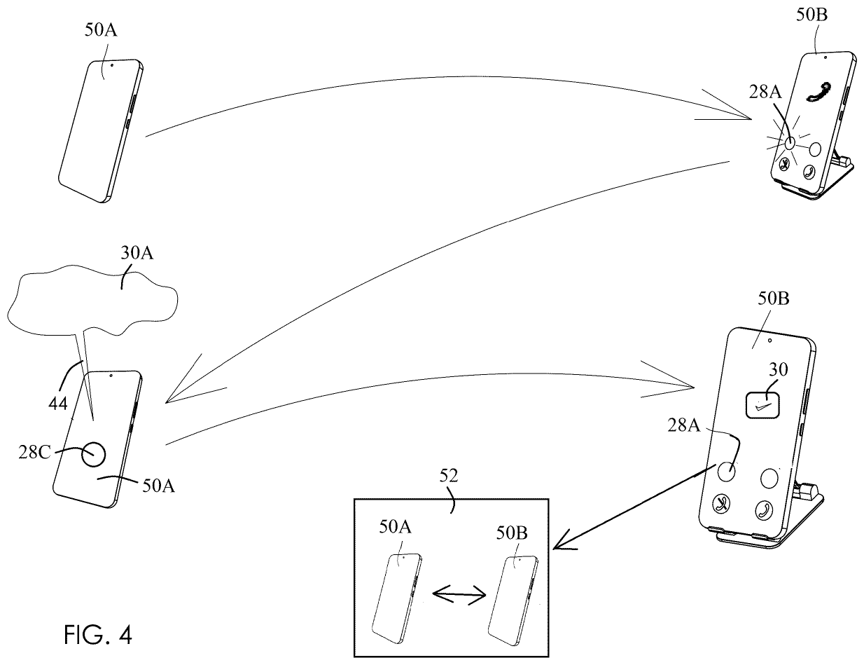

FIG. 4 depicts an additional step of receiving or rejecting the phone call of FIG. 3.

According to an additional embodiment, once the user of phone 50A has pressed on icon 28C, phone 50B displays an icon 32, and the user of phone 50B must confirm again, such as by pressing icon 28A again, and only then conversation 52 is established.

Thus, in one aspect, the invention is directed to a method for establishing a phone conversation (52), the method including the steps of:
a first phone (50A) calls a second phone (50B); and
upon the calling and prior to establishing the phone conversation (52), allowing a user of the second phone (50B) to communicate a first message (30A) to the first phone (50A).

The first message (30A) may be a pre-prepared message, and/or a message prepared by an artificial intelligence (AI) agent.

The method may further include the step of:
upon receiving by the first phone (50A) the message (30A) and prior to establishing the phone conversation (52), allowing a user of the second phone (50B) to cancel the calling or to establish the conversation (52).

The method may further include the step of:
upon receiving by the first phone (50A), the message (30A) and prior to establishing the phone conversation (52), allowing a user of the first phone (50A) to communicate a second message (30B) to the second phone (50B), for allowing establishing the conversation (52).

The method may further include the step of:
upon receiving by the first phone (50A), the message (30A) and prior to establishing the phone conversation (52), allowing a user of the first phone (50A) to communicate a second message (30B) to the second phone (50B); and
upon receiving by the second phone (50B), the second message (30A) and prior to establishing the phone conversation (52), allowing the user of the second phone (50B) to cancel the calling or to establish the conversation (52).

In another aspect, the invention is directed to an application (10) for establishing a phone conversation (52), the application (10) including:
a first menu (28A), for being applicable by a second phone (50B) receiving a call from a first phone (50A) and prior to establishing the phone conversation (52), the first menu (28A) for communicating a first message (30A) to the first phone (50A).

The application (10) may further include:
a second menu (28C), for being applicable by the first phone (50A) upon receiving the first message (30A) and prior to establishing the phone conversation (52), the second menu (28C) for communicating a second message (30B) to the second phone (50B).

In the figures and description herein, the following reference numbers (Reference Signs List) have been mentioned:
number 10 denotes the application for establishing a phone conversation according to one embodiment of the invention;
12: icon displayed;
14,16: prior art menus applied by icons, for operating their functions by the user;
20: person calling;
22: driver;
24: steering wheel;
28A,28B,28C: menus applied by icons, for operating their functions by the user;
30A: pre-prepared or AI-prepared message communicated upon selecting menu 28A;
30B: pre-prepared or AI-prepared message communicated upon selecting menu 28B;
32: icon of display;
44: announcement;
50A,50B: phones;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A method for establishing a phone conversation, the method comprising the steps of:
a first phone calls a second phone; and
upon said calling and prior to establishing the phone conversation, allowing a user of said second phone to communicate a first message to said first phone.

2. The method according to claim 1, wherein said first message comprises at least member selected from a group consisting of: pre-prepared message, message prepared by an artificial intelligence (AI) agent.

3. The method according to claim 1, further comprising the step of:
upon receiving by said first phone said message and prior to establishing the phone conversation, allowing a user of said second phone to cancel said calling or to establish the conversation.

4. The method according to claim 1, further comprising the step of:
upon receiving by said first phone, said message and prior to establishing the phone conversation, allowing a user of said first phone to communicate a second message to said second phone, for allowing establishing the conversation.

5. The method according to claim 1, further comprising the step of:
upon receiving by said first phone, said message and prior to establishing the phone conversation, allowing a user of said first phone to communicate a second message to said second phone; and
upon receiving by said second phone, said second message and prior to establishing the phone conversation, allowing the user of said second phone to cancel said calling or to establish the conversation.

6. An application for establishing a phone conversation, the application comprising:
a first menu, for being applicable by a second phone receiving a call from a first phone and prior to establishing the phone conversation, said first menu for communicating a first message to said first phone.

7. The application according to claim 5, further comprising:
a second menu, for being applicable by said first phone upon receiving said first message and prior to establishing the phone conversation, said second menu for communicating a second pre-prepared message to said second phone.
